(19) United States
(12) Patent Application Publication
(10) Pub. No.: US 2014/0341659 A1
(43) Pub. Date: Nov. 20, 2014

(54) HALF ROUND FILE ATTACHMENT FOR SAW

(71) Applicant: Russell Harrell, Oak City, NC (US)

(72) Inventor: Russell Harrell, Oak City, NC (US)

(21) Appl. No.: 13/893,696

(22) Filed: May 14, 2013

(51) Int. Cl. B23D 71/00; B27B 19/00

(52) U.S. Cl. CPC B23D 71/00; B27B 19/002
USPC 407/29.14

(57) ABSTRACT

A half-round file attachment for a saw comprising a blade that extends the length of the half-round file attachment, the blade includes a first end and a second end; a connection at the first end, where the connection fastens the blade to the saw; a flat side of the blade, where a surface of the flat side is covered with a plurality of sharp parallel teeth to remove small amounts of material from work piece; and a rounded side on an opposite side of the blade from the flat side, where a surface of the rounded side is also covered with the plurality of sharp parallel teeth. The blade is tapered to enable filing of work pieces of various sizes.

### BACKGROUND OF THE INVENTION

1. Field of the Invention

The present invention relates to a file attachment for a reciprocating saw, where the attachment includes a rounded side.

2. Description of Related Art

Files are tools commonly used to remove small amounts of material from a piece of wood thereby smoothing and delicately shaping the outer surface of the wood. Various types of files are available ranging from course to fine toothed surfaces, short and long blade lengths, and flat and round blade shapes. Each type of blade serves a different purpose whether for quick filing which removes a significant amount of the wood in a short period of time, or for circular projects which need the inner surfaces smoothed.

Many times the files are available in sets and include handles for each file. The handle allows the user to manually maneuver the blade on the wood surface for total control and stability. Some files include connections that enable attachment to power saws. With the saw attachment, very rapid movement of the file blade permits fast filing in a shortened amount of time. While various files are available with standard handles, not as many are available for attachment to a saw. Most saw attached files are flat therefore limiting the types of work pieces that may be rapidly filed.

Therefore it would be beneficial in the art to provide a file for attachment to a saw that includes more than simply a flat side. It would also be desirable in the art for the file attachment to be shaped in a way as to permit a single file to fit for varying sized work pieces.

### SUMMARY OF THE INVENTION

In view of the foregoing disadvantages inherent in the prior art, the general purpose of the present invention is to provide a half-round file attachment for a saw, configured to include all of the advantages of the prior art, and to overcome the drawbacks inherent therein.

Accordingly, an object of the present invention is to provide a file attachment for a saw that includes a flat side and a round side.

Another object of the present invention is to provide a file attachment for a saw that tapers to enable filing within rounded or circular work pieces of varying radiuses.

To achieve the above objects, in an aspect of the present invention, a half-round file attachment is described comprising a blade that extends the length of the half-round file attachment, the blade includes a first end and a second end; a connection at the first end, where the connection fastens the blade to the saw; a flat side of the blade, where a surface of the flat side is covered with a plurality of sharp parallel teeth to remove small amounts of material from work piece; and a rounded side on an opposite side of the blade from the flat side, where a surface of the rounded side is also covered with the plurality of sharp parallel teeth. The blade is tapered to enable filing of work pieces of various sizes.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a flat side view of a half-round file attachment for a saw in accordance with an exemplary embodiment of the present invention; and

FIG. 2 depicts a rounded side view of a half-round file attachment for a saw in accordance with an exemplary embodiment of the present invention.

Like reference numerals refer to like parts throughout the description of several views of the drawings.

### DETAILED DESCRIPTION OF THE DRAWINGS

The present invention relates to a file attachment for a reciprocating saw, where the attachment includes a rounded side. The present invention provides a half-round file attachment to provide an automatic file with both a flat file side and a curved file side for dual purpose filing. The half-round file attachment easily attaches to a power tool, like a reciprocating saw, to enable a user to quickly file a work piece. The blade of the file may taper to allow filing pieces of various sizes and radiuses.

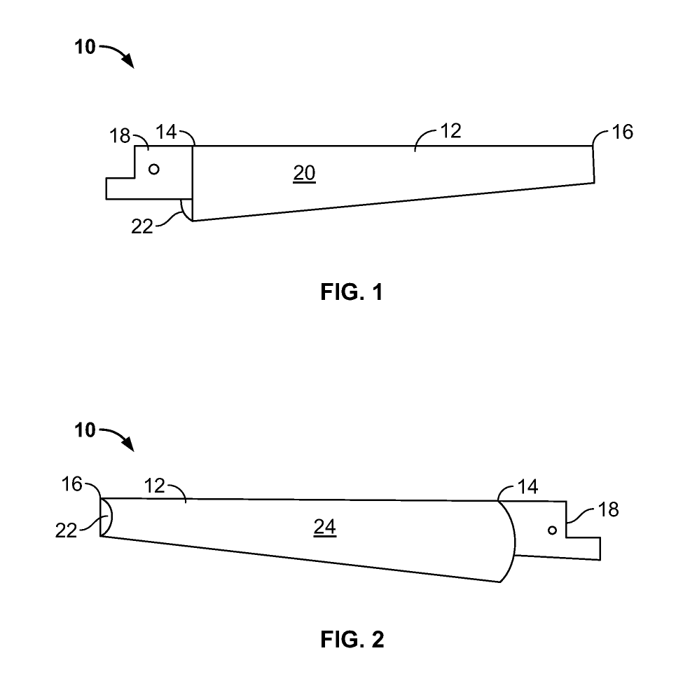

Turning now descriptively to the drawings, referring to FIG. 1, a half-round file attachment 10 is shown in accordance with an exemplary embodiment of the present invention. The half-round file attachment 10 includes a blade 12 to extend the entire length of the file 10. The blade 12 may be made from hardened steel, and ranges in length from 6-12 inches. The blade 12 includes two ends, a first end 14 and a second end 16. The first end is an attachment end 14 that is fastened to a connection 18. The connection 18 attaches the half-round file attachment 10 to a reciprocating saw. The second end is a tapered end 16. The attachment end 14 may be ⅞ inches in width and the tapered end 16 may be ½ inch in width.

FIG. 1 illustrates a flat side 20 of the blade 12 in the forefront. The flat side 20 comprises a surface that is textured with many sharp parallel teeth to remove fine amounts of material from the work piece. As illustrated in FIG. 2, the blade 12 includes a curved side 24 that is also includes a surface covered in the textured, sharp, parallel teeth. The curved side 24 includes a raised edge 22 that extends the entire length of the blade 12. The curved side 24 of the blade 12 allows for filing within rounded or circular portions of the work piece. Additionally, by having a tapered blade 12 the half-round file attachment 10 is able to file work pieces of differing sizes without having to exchange the blade 12.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A half-round file attachment for a saw comprising:
a. a blade that extends the length of the half-round file attachment, the blade includes a first end and a second end;
b. a connection at the first end, where the connection fastens the blade to the saw;
c. a flat side of the blade, where a surface of the flat side is covered with a plurality of sharp parallel teeth to remove small amounts of material from work piece; and
d. a rounded side on an opposite side of the blade from the flat side, where a surface of the rounded side is also covered with the plurality of sharp parallel teeth.

2. The half-round file attachment according to claim 1, where the connection of the attachment end fastens the blade to a reciprocating saw.

3. The half-round file attachment according to claim 1, where the blade is tapered, and where the first end is an attachment end and the second end is a tapered end.

4. The half-round file attachment according to claim 3, where the attachment end is ⅞ inches in width, and where the tapered end is ½ inch in width.

5. The half-round file attachment according to claim 1, where the blade ranges from 6-12 inches in length.
